(19) United States
(12) Patent Application Publication
(10) Pub. No.: US 2004/0015615 A1
(43) Pub. Date: Jan. 22, 2004

(54) Method for performing data transfer of KVM switch

(76) Inventor: Cheng Kuo Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/618,652

(22) Filed: Jul. 15, 2003

Related U.S. Application Data
(63) Continuation-in-part of application No. 09/425,187, filed on Oct. 25, 1999, now abandoned.

(51) Int. Cl. G06F 3/00

(52) U.S. Cl. 710/1

(57) ABSTRACT

A method for performing data transfer of keyboard-video-mouse (KVM) switch, especially referring to a method that can make the KVM switch transmit data to or receive data from multiple computers simultaneously. The method includes steps as: storing peripheral data ready for transfer in data registers; setting transmit flag register (Tx flag) and receive flag register; transferring (Rx flag) a bit of the peripheral data from each of the data registers to each of the data pins during a clock cycle at each of the I/O ports corresponding to the Tx flag set; receiving a bit of control data from each of the data pin and storing the bit of said control data to each of the data register during the clock cycle at each of the I/O ports corresponding to the Rx flag set. Thereby, the method can transmit data to or receive data from multiple computers simultaneously.

### CROSS REFERENCE TO RELATED APPLICATION

This application is a continuation-in-part of U.S. application Ser. No. 09/425,187, filed on Oct. 25, 1999 and entitled “control method for simultaneously simulating multiple computer peripherals.”

### FIELD OF THE INVENTION

The present invention relates to a method for performing data transfer of keyboard-video-mouse (KVM) switch, especially for a method that can make the KVM switch transmit data to or receive data from multiple computers simultaneously.

### BACKGROUND OF THE INVENTION

Conventionally, KVM switches enable a single keyboard, mouse and monitor to logically connect to any one of several computers simultaneously. One embodiment of a KVM switch 200 is shown in FIG. 1. Using commands from input devices 300 (i.e. keyboard and mouse), the user may switch between the computers 100 (i.e. personal computers (PC) 1001˜1003).

Generally, the conventional method for performing data transfer of KVM switch is polling. It means that the KVM switch 200 will perform data transfer from the PC 1001 to the PC 1003 orderly and cyclically. However, the transmission speed between a computer and input devices is a fixed standard (about 40˜60 kpbs), when the number of computers increases (e.g. when 8, 16 or more computers require to perform data transfer simultaneously), the conventional method induces a problem of exceeding the latency time. For example, if there are 16 computers ready for data transfer and each transfer takes 1 second in average, then a computer has to wait for another 15 seconds before been serviced the next time which usually exceeds the latency time.

As shown in FIG. 2, the problem described above can be resolved by using a multiple of data processors 221˜223. The number of the data processors 221˜223 should be equal to that of the computers 100. Since the transmission speed within the KVM switch 200′ is much faster than the transmission speed between the computers 100 and the input devices 300, the main processor 210′ can provide the ready data to the data processors 221˜223 in advance. Moreover, each of the data processors 221˜223 is able to transmit data to or receive data from its corresponding computers 100 independently. Hence, the KVM switch 200′ can perform data transfer in time when requested by the computers 100.

Although the structure of the KVM switch 200′ can resolve the problem of exceeding the latency time, it induces another problem. Since the number of additional data processors 221˜223 is equal to that of the computers 100 and they are usually very expensive, the cost of the KVM switch 200′ will increase enormously with the amount of the computers 100. That is uneconomic and inefficient.

Accordingly, as discussed above, the conventional method for performing data transfer of KVM switch obviously still has some drawbacks and limitation that could be improved. The present invention aims to resolve the drawbacks in the prior art.

### SUMMARY OF THE INVENTION

An object of the present invention is to provide a method for performing data transfer of KVM switch that uses less circuit to simultaneously transfer data between several computers and input devices.

Another object of the present invention is to provide a method for performing data transfer of KVM switch that can shorten the transferring time when performing data transfer between several computers and input devices.

Still another object of the present invention is to provide a method for performing data transfer of KVM switch that can perform data transfer between several computers and input devices within a clock cycle.

For reaching the objects above, the present invention provides a method for performing data transfer of a KVM switch. The KVM switch has a main processor with a plurality of input/output (I/O) ports each connecting to a corresponding computer. Each of the I/O ports corresponds to a Tx flag, a Rx flag and a data register and has a data pin and a clock pin. The method comprises the following steps:

(a) storing peripheral data in the data register corresponding to each of the I/O port for which said peripheral data is ready for transfer;

(b) setting the Tx flag corresponding to each of the I/O ports connecting to the corresponding computer ready for receiving said peripheral data and having said peripheral data ready for transfer;

(c) setting the Rx flag corresponding to each of the I/O ports connecting to the corresponding computer ready for sending control data;

(d) at each of the I/O ports corresponding to the Tx flag set, transferring a bit of said peripheral data from the data register thereof to the data pin thereof during a clock cycle;

(e) at each of the I/O ports corresponding to the Rx flag set, receiving a bit of said control data from the data pin thereof and storing the bit of said control data to the data register thereof during the clock cycle; and

(f) repeating step (d) and (e) until reaching a predetermined number of times.

The various objects and advantages of the present invention will be more readily understood from the following detailed description when read in conjunction with the appended drawings, in which:

### BRIEF DESCRIPTION OF DRAWINGS

FIG. 1 shows a schematic diagram of a conventional KVM switch.

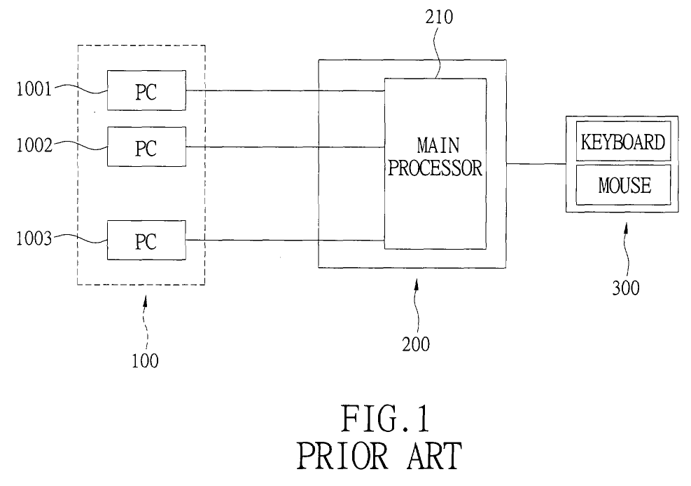

FIG. 2 shows a schematic diagram of another conventional KVM switch.

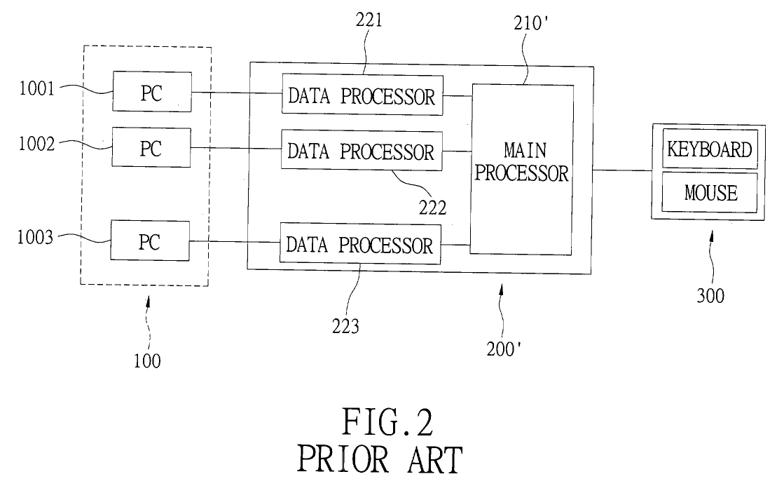

FIG. 3 shows a block diagram of the KVM switch complied with the present invention.

FIG. 4 shows a circuit diagram of the main processor of the KVM switch complied with the present invention.

FIG. 5 is a timing diagram when the main processor sends data to the computers.

FIG. 6 is a timing diagram when the computers sends data to the main processor.

FIG. 7 shows the flowchart for simultaneously sending data to the computers.

FIG. 8 shows the flowchart for simultaneously receiving data from the computers.

FIG. 9 shows the flowchart for simultaneously receiving and sending data.

### DETAILED DESCRIPTION OF THE PREFERRED EMBODIMENTS

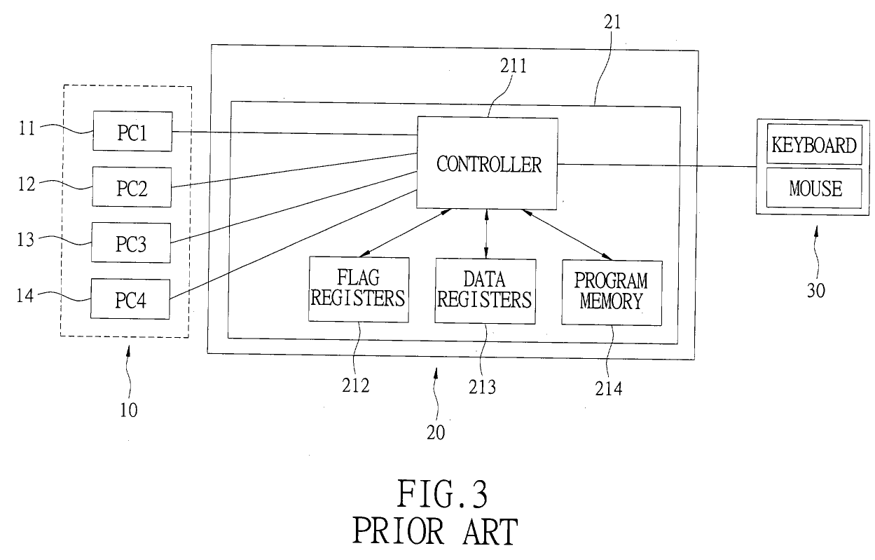

Please refer to FIG. 3, which shows a circuit block diagram of a KVM switch used for implementing the method for performing data transfer of KVM switch complied with the present invention. The KVM switch 20 comprises a main processor 21, which has a controller 211, a plurality of flag registers 212 and data registers 213 and a program memory 214. The main processor 21 connects with a plurality of computers 10 (including personal computers (PC) 11˜14, i.e. PC1˜4) and input devices 30 (i.e. keyboard and mouse). In practice, the number of the computers 10 can be 8, 16 or more.

Therein, the main processor 21 has a plurality of input/output (I/O) ports for connecting the I/O ports of the computers 10 and the input devices 30, wherein each of the I/O ports of the main processor 21 and the computers 10 has a data pin and clock pin. The flag registers 212 include transmit flag registers and receive flag registers and each of the I/O ports of the main processor 21 corresponds to a transmit flag register (Tx flag) and a receive flag register (Rx flag). Besides, each of the I/O ports of the main processor 21 also corresponds to one of the data registers 213. Further, the program memory 214 for controlling the controller 211 to perform data transfer between the computers 10 and the input devices 30.

In practice, the I/O port of each computer 10 can be a transmission port with transmission data format same as PC/AT keyboard or with similar transmission data format such as PS/2 keyboard, PS/2 mouse, SUN keyboard and mouse, DEC ALPHA keyboard and mouse.

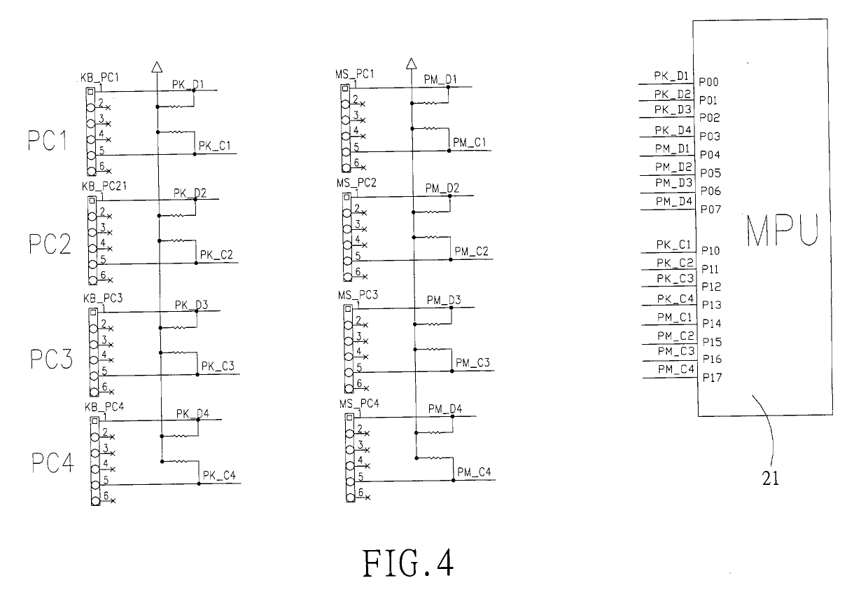

Please refer to FIG. 4, which shows the circuit diagram of the main processor 21 complied with the present invention. The I/O port pins (P00-P07, P10-P17) of the main processor 21 are connected to the computers 10 (i.e. PC1˜4), wherein the main processor 21 is a microprocessor unit (MPU) with other port pins connected to the input devices 30.

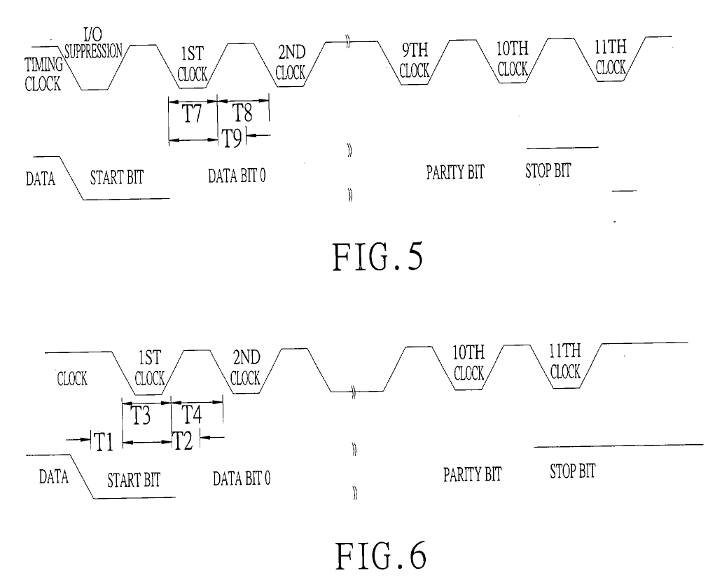

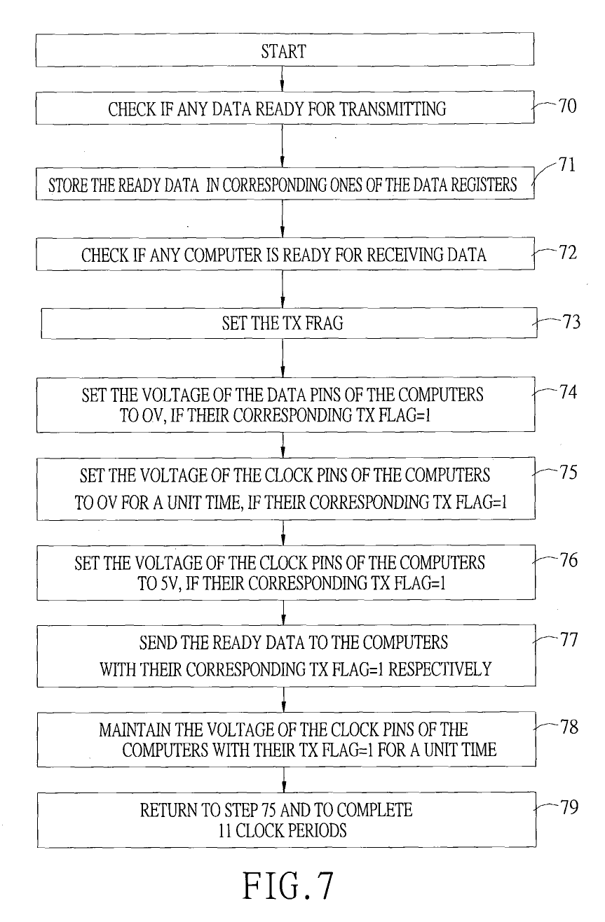

FIG. 5 is the timing diagram when the main processor 21 sends data to the computers 10, and FIG. 6 is the timing diagram when the computers sends data to the main processor 21.

As shown in those figures, the first clock period is a start bit, the second to the ninth clock period are data bits, the tenth clock period is a parity bit and the eleventh clock period is a stop bit. The parameters have the following definitions:

T1: data transfer at the negative edge of the clock (CLK)

T2: data transfer at the positive edge of the CLK

T3: non-active time of the CLK

T4: active time of the CLK

T7: non-active time of the CLK

T8: active time of the CLK

T9: data transfer time

The main processor 21 does not perform another data transfer while in the eleventh clock period.

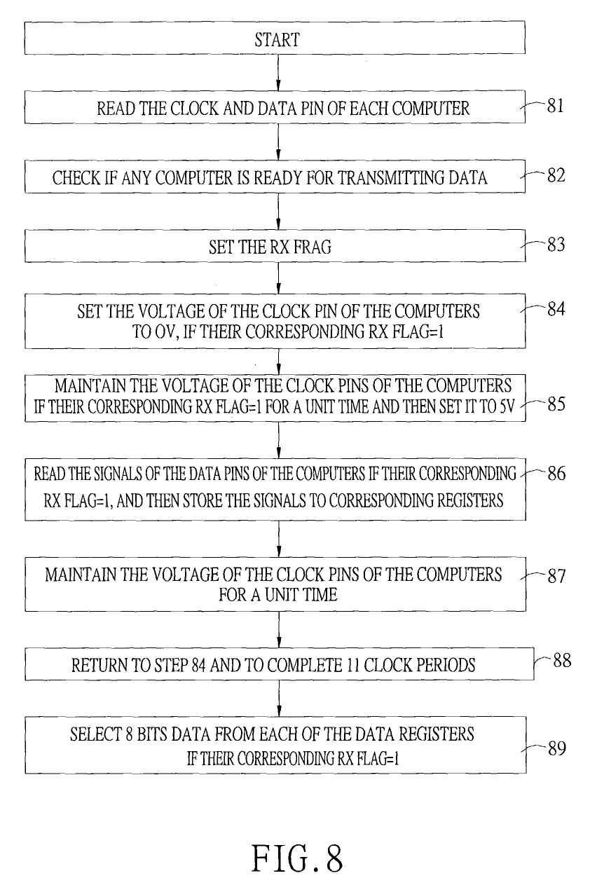

FIG. 7 shows the flowchart for simultaneously sending data to the computers 10.

Step 70: In the beginning, the controller 211 of the main processor 21 checks if there is any data ready for transmitting.

Step 71: If yes, the controller 211 stores the ready data to corresponding data registers 213.

Step 72: The controller 211 checks if there is any computer ready for receiving data.

In practice, the controller 211 checks the data pins and clock pins of the computers 10 to find out which one is ready for receiving data. If voltages of the data pin and clock pin of a computer are both 5V, then the computer will be identified as a ready one.

Step 73: If there is a computer ready for receiving data and its corresponding data register 213 has data ready to send, then the controller 211 will set the corresponding Tx flag=1. Otherwise, set the corresponding Tx flag register=0.

Step 74: Then, the controller 211 will set the voltage of the data pins of the computers 10 to 0V if their corresponding Tx flag=1.

Step 75: The controller 211 will set the voltage of the clock pins of the computers 10 0V for a unit time (half a clock cycle), if their corresponding Tx flag=1.

Step 76: Then, the controller 211 will set the voltage of the clock pins of the computers 10 to 5V, if their corresponding Tx flag=1.

Step 77: Then, the controller 211 will send the ready data to the computers 10 with their corresponding Tx flag=1 respectively.

Step 78: The controller 211 will maintain the voltages of the clock pins of the computers 10 for a unit time (half a clock cycle), if their corresponding Tx flag=1.

Step 79: return to step 75 and perform data transfer to complete 11 clock periods.

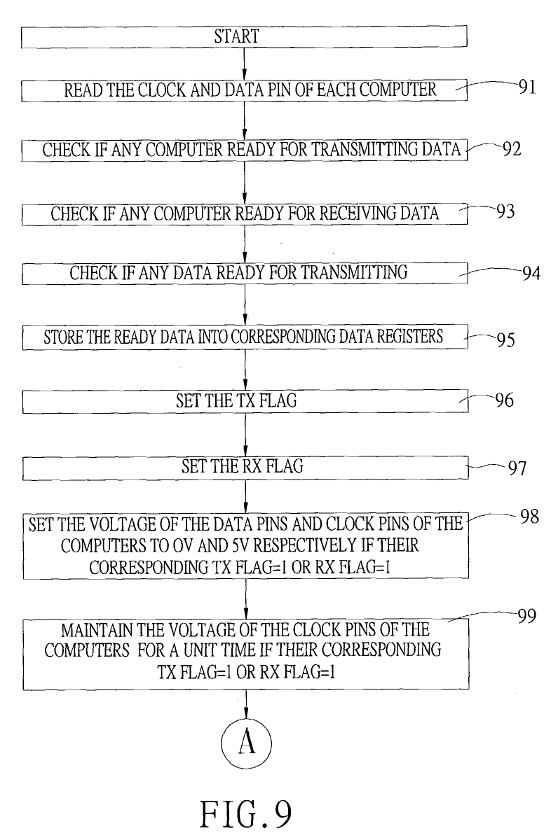

FIG. 8 shows the flowchart for simultaneously receiving data from the computers 10.

Step 81: In the beginning, the controller 211 of the main processor 21 will read the clock and data pin of each computer.

Step 82: Then, it will check if any computer is ready for transmitting data.

In practice, the controller 211 will check the data pins and clock pins of the computers 10 to find out which one is ready for transmitting data. If the voltages of the data pin and clock pin of a computer are 0V and 5V respectively, then the computer will be identified as a ready one.

Step 83: If there is a computer ready for transmitting data, then the controller 211 will set its corresponding Rx flag=1. Otherwise, set the corresponding Rx flag register=0.

Step 84: Then, the controller 211 will set the voltage of the clock pins of the computers 10 to 0V, if their corresponding Rx flag=1.

Step 85: The controller 211 will maintain the voltage of the clock pins of the computers 10 for a unit time if their corresponding Rx flag=1, then set it to 5V.

Step 86: Then, the controller 211 will read the signals of the data pins of the computers 10 if their corresponding Rx flag=1, then it will store the signals to corresponding data registers 213.

Step 87: The controller 211 will maintains the voltage of the clock pins of the computers 10 for a unit time, if their corresponding Rx flag=1.

Step 88: return to step 84 and performs to complete 11 clock periods.

Step 89: Then, the controller 211 will select 8 bits data from each of the data registers 213 as received data if their corresponding Rx flag=1.

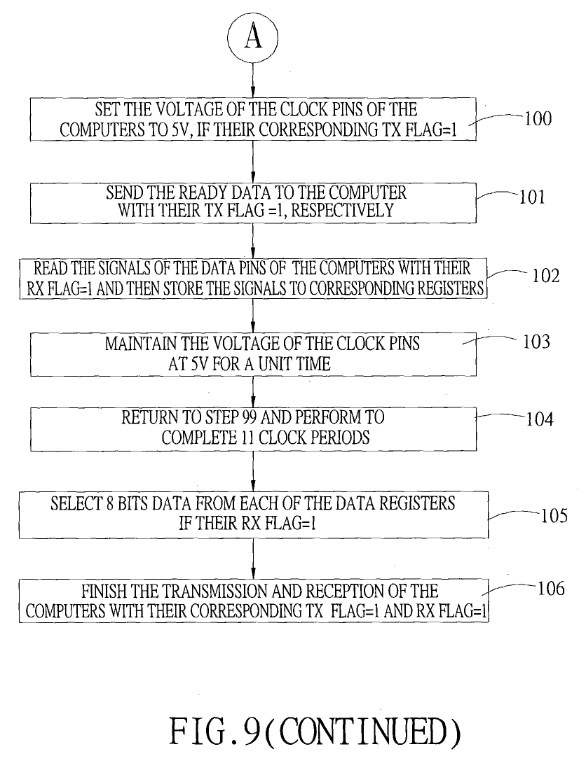

FIG. 9 shows the flowchart for simultaneously receiving and sending data.

Step 91 In the beginning, the controller 211 of the main processor 21 will read the clock and data pin of each computer.

Step 92: It will check if any computer is ready for transmitting data.

Step 93: And, it will check if any computer is ready for receiving data.

Step 94: Then, the controller 211 will check if any data is ready for transmitting.

Step 95: It stores the ready data in corresponding data registers 213, respectively.

Step 96: If there is a computer ready for receiving data and its corresponding data register 213 has data ready to send, then the controller 211 will set the corresponding Tx flag=1. Otherwise, set the corresponding Tx flag register=0.

Step 97: If there is a computer ready for transmitting data, then the controller 211 will set its corresponding Rx flag=1. Otherwise, set the corresponding Rx flag register=0.

Step 98: Then, the controller 211 will set the voltage of the data pins and clock pins of the computers 10 to 0V and 5V respectively, if their corresponding Tx flag=1 or Rx flag=1.

Step 99: The controller 211 will maintain the voltage of the clock pins of the computers 10 for a unit time, if their corresponding Tx flag=1 or Rx flag=1.

Step 100: Then, the controller 211 will set the voltage of the clock pins of the computers 10 to 5V, if their corresponding Tx flag=1.

Step 101: The controller 211 will send the ready data to the computers 10 with their Tx flag=1, respectively.

Step 102: The controller 211 will read the signals of the data pins of the computers 10 with their Rx flag=1 and then it will store the signals to corresponding data registers 213.

Step 103: Maintain the voltage of the clock pins at 5V for a unit time.

Step 104: Return to step 99 and perform to complete 111 clock periods.

Step 105: Then, the controller 211 will select 8 bits data from each of the data registers 213 as received data if their corresponding Rx flag=1.

Step 106: Finish the transmission and reception of the computers 10 with their corresponding Tx flag=1 and Rx flag=1.

To sum up, the present invention provides a method for performing data transfer of KVM switch. It can simultaneously perform data transfer between multiple computers and input devices. And can shorten the transferring time of data transfer. Further, it can perform data transfer to multiple computers within a clock cycle. More particularly, the present invention uses less circuit to perform data transfer to multiple computers in a far more efficient manner.

Although the present invention has been described with reference to the preferred embodiment thereof, it will be understood that the invention is not limited to the details thereof. Various substitutions and modifications have suggested in the foregoing description, and other will occur to those of ordinary skill in the art. For example, the MPU can be replaced by ASIC (application specific integrated circuit), EPLD (electrically programmer device) or CPLD (complex programmable logic device). Therefore, all such substitutions and modifications are intended to be embraced within the scope of the invention as defined in the appended claims.

I claim

1. A method for performing data transfer of a keyboard-video-mouse (KVM) switch, the KVM switch having a main processor with a plurality of input/output (I/O) ports each connecting to a corresponding computer, each of the I/O ports corresponding to a transmit flag register (Tx flag) and a data register and having a data pin, the method comprising following steps:
(a) storing peripheral data in the data register corresponding to each of the I/O ports for which said peripheral data is ready for transfer;
(b) setting the Tx flag corresponding to each of the I/O ports connecting to the corresponding computer ready for receiving said peripheral data and having said peripheral data ready for transfer;
(c) at each of the I/O ports corresponding to the Tx flag set, transferring a bit of said peripheral data from the data register thereof to the data pin thereof during a clock cycle; and
(d) repeating step (c) until reaching a predetermined number of times.

2. The method as claimed in claim 1, wherein each of the I/O ports has a clock pin, and the method further comprising:
checking the data pin and clock pin of each of the I/O ports to find out the computer ready for receiving said peripheral data.

3. A method for performing data transfer of a KVM switch, the KVM switch having a main processor with a plurality of I/O ports each connecting to a corresponding computer, each of the I/O ports corresponding to a receive flag register (Rx flag) and a data register and having a data pin, the method comprising following steps:
(a) setting the Rx flag corresponding to each of the I/O ports connecting to the corresponding computer ready for sending control data;
(b) at each of the I/O ports corresponding to the Rx flag set, receiving a bit of said control data from the data pin thereof and storing the bit of said control data to the data register thereof during a clock cycle; and
(c) repeating step (b) until reaching a predetermined number of times.

4. The method as claimed in claim 3, wherein each of the I/O ports has a clock pin, and the method further comprising:
checking the data pin and clock pin of each of the I/O ports to find out the computer ready for sending said control data.

5. A method for performing data transfer of a KVM switch, the KVM switch having a main processor with a plurality of input/output (I/O) ports each connecting to a corresponding computer, each of the I/O ports corresponding to a Tx flag, a Rx flag and a data register and having a data pin, the method comprising following steps:
(a) storing peripheral data in the data register corresponding to each of the I/O ports for which said peripheral data is ready for transfer;
(b) setting the Tx flag corresponding to each of the I/O ports connecting to the corresponding computer ready for receiving said peripheral data and having said peripheral data ready for transfer;
(c) setting the Rx flag corresponding to each of the I/O ports connecting to the corresponding computer ready for sending control data;
(d) at each of the I/O ports corresponding to the Tx flag set, transferring a bit of said peripheral data from the data register thereof to the data pin thereof during a clock cycle;
(e) at each of the I/O ports corresponding to the Rx flag set, receiving a bit of said control data from the data pin thereof and storing the bit of said control data to the data register thereof during the clock cycle; and
(f) repeating step (d) and (e) until reaching a predetermined number of times.

6. The method as claimed in claim 5, wherein each of the I/O ports has a clock pin, and the method further comprising:
checking the data pin and clock pin of each of the I/O ports to find out the computer ready for receiving said peripheral data.

7. The method as claimed in claim 5, wherein each of the I/O ports has a clock pin, and the method further comprising:
checking the data pin and clock pin of each of the I/O ports to find out the computer ready for sending said control data.
